(19) United States
(12) Patent Application Publication
(10) Pub. No.: US 2021/0363797 A1
(43) Pub. Date: Nov. 25, 2021

(54) Interlock for Enclosures

(71) Applicant: Hoffman Enclosures, Inc., Anoka, MN (US)

(72) Inventors: Joseph D. Ricke, Arden Hills, MN (US); Gerardo Villegas Hinojosa, Reynosa (MX); Omar Alejandro Rodriquez Perez, Reynosa (MX)

(21) Appl. No.: 17/327,164

(22) Filed: May 21, 2021

Related U.S. Application Data
(60) Provisional application No. 63/028,236, filed on May 21, 2020.

(51) Int. Cl. E05C 7/00; E05C 1/00; E05C 3/00

(52) U.S. Cl. CPC E05C 7/00; E05C 3/006; E05C 1/004

(57) ABSTRACT

An interlock for an enclosure can include a primary interlock activator that translates a rod assembly upon movement of a primary door of the enclosure and a secondary interlock activator. The secondary interlock activator can be configured to be one of translated or rotated relative to the enclosure, by the rod assembly, to move a latch hook of the secondary interlock activator between engaged and disengaged positions. The secondary interlock activator can be configured to be placed in the engaged position by the translation of the rod assembly, when the primary door is closed, to prevent the secondary door from being opened. The primary interlock activator can be configured to be placed in the disengaged position by the translation of the rod assembly, when the primary door is open, to allow the secondary door to be opened.

### RELATED APPLICATIONS

This application is based on, claims priority to, and incorporates herein by reference in its entirety U.S. Ser. No. 63/028,236 filed May 21, 2020, and entitled “Interlock For Enclosures.”

### BACKGROUND

Electrical equipment can be installed in enclosures with doors to allow users to access the equipment. In some installations, it may be useful to selectively prevent one or more doors from being opened. For example, in some installations, it may be useful to prevent a main door from being opened unless power to the enclosure has been appropriately disconnected.

### SUMMARY

In some embodiments, an interlock is provided for controlling doors on an enclosure that includes a primary door, a first secondary door and a second secondary door. The interlock can include a primary interlock activator, a rod assembly, a first secondary interlock activator and a second secondary interlock activator. The primary interlock activator may be positioned above the primary door and can include a pivot arm having a first position and a second position. The pivot arm may be configured to be in the first position when the primary door is in a closed position and may be configured to be in the second position when the primary door is in an open position. The rod assembly is coupled to the primary interlock activator. The first secondary interlock activator can be positioned above the first secondary door and is coupled to the rod assembly. The first secondary interlock activator can include a slide body that is slidably secured to the enclosure, a latch hook that is rotatably supported on the slide body and a swivel collar that is rotatably supported on the slide body. The first secondary interlock activator can have an engaged position and a disengaged position. The first secondary interlock activator may be in the engaged position when the primary door is in the closed position and may be in the disengaged position when the primary door is in the open position. The second secondary interlock activator can be positioned above the second secondary door and is coupled to the rod assembly. The second secondary interlock activator can include a pivot body that is rotatably secured to the enclosure, a latch hook that is rotatably supported on the pivot body and a swivel collar that is rotatably supported on the pivot body. The second secondary interlock activator can have an engaged position and a disengaged position. The second secondary interlock activator may be in the engaged position when the primary door is in the closed position and may be in the disengaged position when the primary door is in the open position

In some embodiments, an interlock is provided for controlling doors on an enclosure that includes a primary door, a first secondary door and a second secondary door. The interlock can include a primary interlock activator positioned above the primary door, a first secondary interlock activator positioned above the first secondary door and a second secondary interlock activator positioned above the second secondary door. The primary interlock activator is coupled to a rod assembly and may be configured to translate the rod assembly relative to the enclosure upon movement of the primary door, The first secondary interlock activator is coupled to the rod assembly and can include a latch hook. The first secondary interlock activator may be configured to slide along an interior of the enclosure upon translation of the rod assembly and move the latch hook between an engaged position and a disengaged position relative to a latch of the first secondary door. The second secondary interlock activator is coupled to the rod assembly and can include a latch hook. The second secondary interlock activator may be configured to rotate relative to the interior of the enclosure upon translation of the rod assembly and move the latch hook between an engaged position and a disengaged position relative to a latch of the second secondary door.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure:

FIG. 1 is an isometric view of a multi-door enclosure for use with an interlock according to an embodiment;

FIG. 2 is an internal elevation view of a primary door and a secondary door of the enclosure of FIG. 1, including an interlock according to an embodiment;

FIG. 3 is an internal elevation view of two secondary doors of the enclosure of FIG. 1, including an interlock according to an embodiment;

FIGS. 4A and 4B are isometric views of the primary interlock activator for a primary door of an enclosure according to an embodiment;

FIGS. 5 and 6 are isometric views of a secondary interlock activator for a secondary door of an enclosure according to an embodiment;

FIGS. 7 and 8 are isometric views of a secondary interlock activator for a secondary door of an enclosure according to an embodiment;

FIGS. 9A and 9B are isometric views of latch hooks for use with secondary interlock activators according to an embodiment;

FIGS. 10A and 10B are side elevation views of operation of the secondary interlock activator of FIGS. 5 and 6 according to an embodiment;

FIGS. 11A and 11B are isometric views of rod connectors for use with interlocks according to embodiments;

FIGS. 12 and 13 are isometric internal views of the primary and secondary doors of FIG. 2 showing operations of the interlock of FIG. 2 according to an embodiment;

FIGS. 14 and 15 are isometric internal views of the secondary doors of FIG. 3 showing operations of the interlock of FIG. 3 according to an embodiment; and

FIG. 16 is an isometric view of a secondary interlock activator for a secondary door of an enclosure according to an embodiment.

### DETAILED DESCRIPTION

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

As used herein, unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise specified or limited, the terms “primary,” “secondary,” and the like are used for convenience to indicate functional or other relationships between different components of interlock systems. For example, “primary” features may be associated with one or more specific “primary” doors of an enclosure, while “secondary features” may be associated with one or more other “secondary” doors of the enclosure. However, the terms “primary” and “secondary” and the like do not necessarily require a particular relative importance of components, or a particular relative order of operations. For example, in some cases, “primary” features may be configured to be activated or deactivated first, and “secondary” features may be configured to be activated or deactivated second, during certain operations for an enclosure. In some cases, however, other associations or orders of activation or deactivation may be employed.

As noted above, it may sometimes be useful to link operation of different doors of an enclosure (e.g., of an electrical enclosure) so that one or more doors not be opened unless another door has been opened first. This may be useful, for example, in enclosures in which power is to be disconnected before operators conduct work within the enclosures. For example, in a multi-bay, multi-door enclosure, it may be useful to ensure that certain (e.g., all) doors cannot be opened while the enclosure is energized. In this regard, a variety of known locking mechanisms can be used to ensure that a primary door cannot be opened unless all relevant parts (e.g., all high voltage bays) of the enclosure have been de-energized. Correspondingly, based on this noted control of a primary door, embodiments of the disclosure can prevent secondary doors from being opened unless a primary door has been opened first—as may not be possible unless the enclosure has been properly de-energized.

For example, some embodiments of the disclosure can include an interlock with a primary interlock activator and one or more secondary interlock activators. The primary interlock activator can be configured to cause a rod assembly (e.g., one or more rods joined by one or more couplers) to be translated or otherwise moved along an enclosure as a primary door is opened and closed. The secondary interlock activators can be secured to the rod assembly in alignment with secondary doors and can be moved by the movement of the rod assembly to permit or prevent a user to open the respective secondary doors depending on the state of the primary door.

In different embodiments, different types of secondary interlock activators can be used. For example, some secondary interlock activators can be configured to be slid (i.e., translated) along an enclosure by movement of a rod assembly, in order to move a latch hook in and out of alignment with a latch for an associated secondary door. Thus, depending on the position of the secondary interlock activators—as depends in turn, via the primary interlock activator, on the position of the primary door—the secondary door may be allowed or not allowed to open. As another example, some secondary interlock activators can be configured to be rotated along an enclosure by movement of a rod assembly, in order to move a latch hook in and out of alignment with a latch for an associated secondary door. Thus, again, depending on the position of the secondary interlock activators—as depends in turn, via the primary interlock activator, on the position of the primary door—the secondary door may be allowed or not allowed to open.

In some embodiments, rotating and translating interlock activators can be combined within a single interlock in order to control multiple secondary doors of an enclosure via movement of a single rod assembly by a primary interlock activator. For example, a rotating interlock activator can be associated with a secondary door that opens in a first direction and a sliding interlock activator can be associated with a secondary door that opens in a second, opposite direction. Thus, via movement of a common rod assembly by a common primary interlock activator, both of the secondary doors can be selectively allowed or not allowed to open.

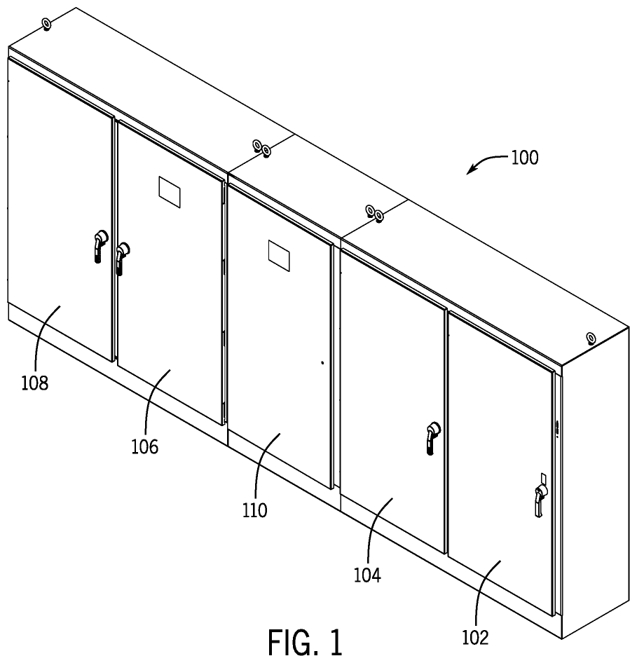

FIG. 1 illustrates an enclosure 100 that can be equipped with an interlock according to an embodiment. The enclosure 100 includes a plurality of bays, with a primary door 102, an adjacent secondary door 104, and additional secondary doors 106, 108, all to be protected by an interlock, as detailed below. A power disconnect (not shown in FIG. 1) is provided for the primary door 102, and can generally prevent the primary door 102 from being opened unless the enclosure 100 is appropriately de-energized.

In the illustrated example, another secondary door 110 opens into a low voltage enclosure and therefore may not be protected by the interlock. As also discussed below, some embodiments of the disclosure can beneficially allow for control of only select doors of an enclosure, including as shown in FIG. 1.

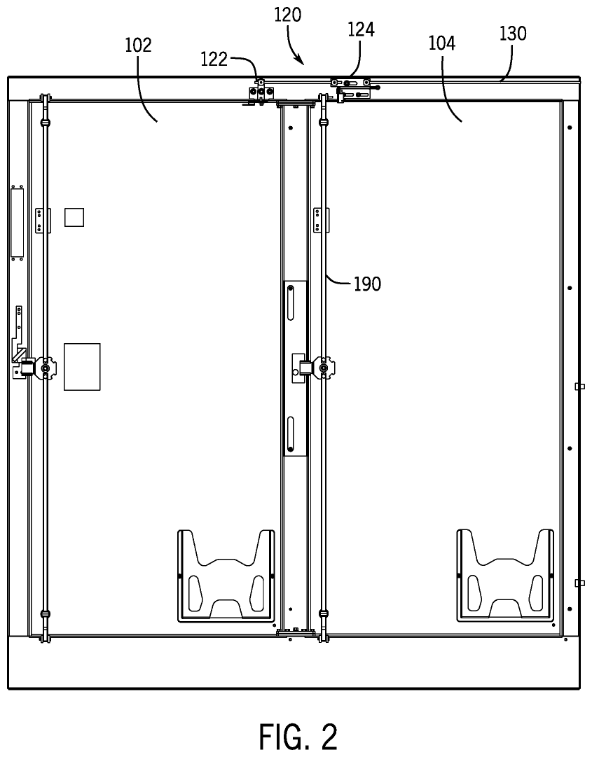

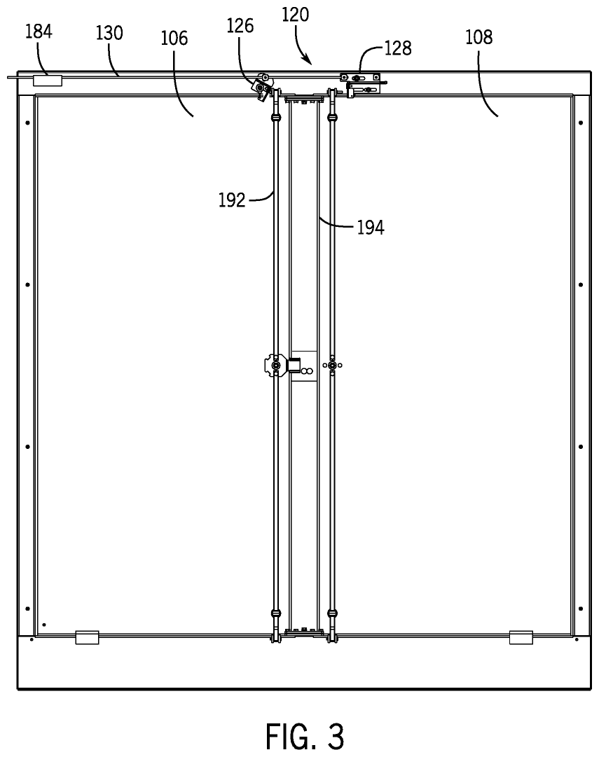

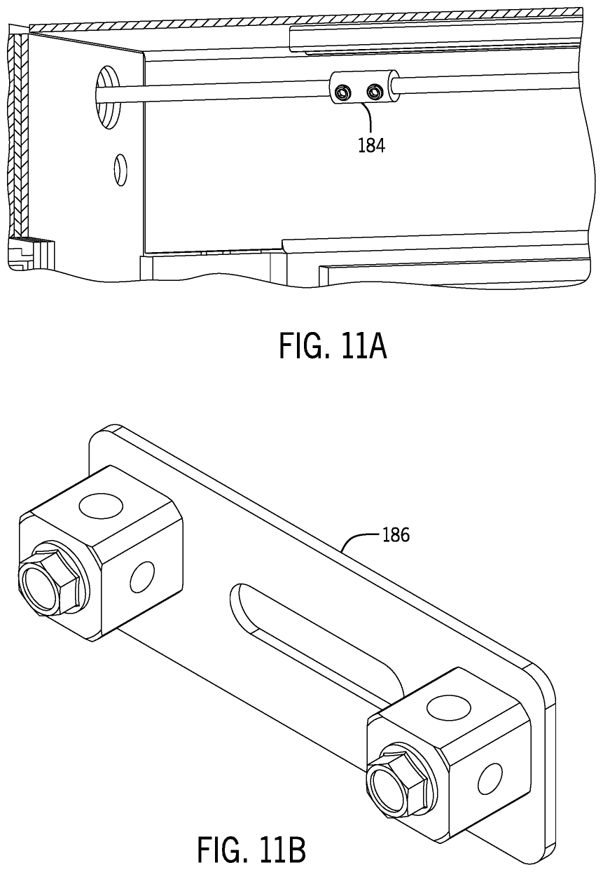

FIGS. 2 and 3 show an internal view of the primary and secondary doors 102, 104, 106, 108 and an interlock 120 according to an embodiment of the disclosure. In particular, the interlock 120 includes a primary interlock activator (“primary interlock activator”) 122 that is linked to a set of secondary interlock activators (“secondary interlock activators”) 124, 126, 128 by a rod assembly 130. In the illustrated example, the rod assembly 130 includes a single rigid rod that extends between the primary interlock activator 122 and the secondary interlock activator 124, a set of rigid rods connected by one or more couplers (e.g., coupler 184 shown in FIG. 3), which extends from the secondary interlock activator 124 to the secondary interlock activator 126 (see FIG. 3), and a further single rigid rod that extends between the secondary interlock activators 126, 128. In other embodiments, however, other rod assemblies are also possible. In some embodiments, the coupler 184 used to secure together the set of rigid rods that extend between the secondary interlock activator 124 (FIG. 2) and the secondary interlock activator 126 (FIG. 3), may be a tube coupler 184, as shown in FIG. 11A. As shown in FIGS. 2 and 3 and described further below, each secondary interlock device activator 124, 126 and 128 may be configured to move between an engaged and a disengaged position relative to a latch rod 190, 192, and 194, respectively, of the secondary doors 104, 106, 108, respectively,

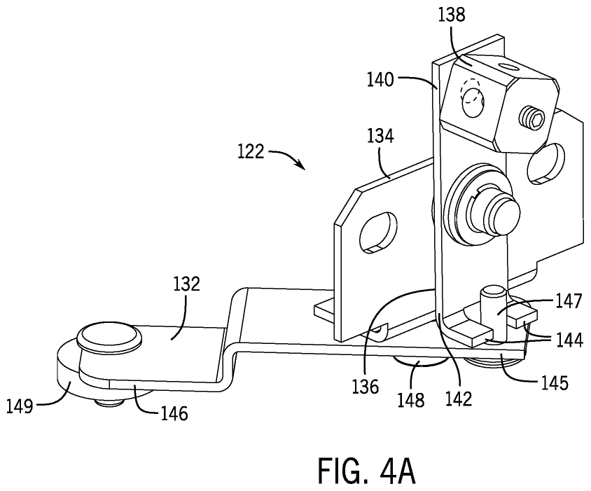

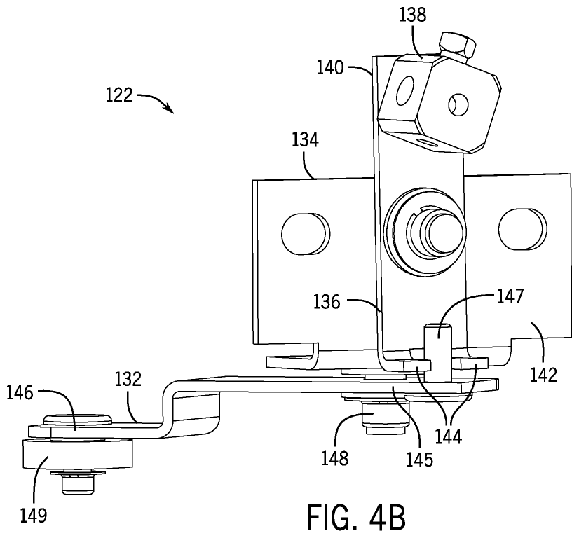

Generally, a primary interlock activator 122 may be configured to translate a rod assembly 130 relative to an enclosure based on the opening and closing of a primary door of the enclosure. As shown in FIGS. 4A and 4B, in the illustrated example, the primary interlock activator 122 includes a door engagement arm 132 having a first end 145 and a second end 146. The second end 146 of door engagement arm 132 may be configured to engage with primary door 102 when the primary door is moved to and positioned in a closed position. In some embodiments, the second end 146 of the door engagement arm may include a roller 149 that may be configured to rotate as the primary door 102 is being closed and engages with the second end 146 of the door engagement arm 132. The door engagement arm 132 is pivotally secured to a support plate 134 at a pivot point 148. A pivot arm 136 is also pivotably secured to the support plate 134, but about a perpendicular rotational axis relative to the door engagement arm 132. The pivot arm 136 pivotably supports a swivel collar 138 at a first end 140 of the picot arm and includes a pinned connection with the door engagement arm 132 at a second end 142 of the pivot arm 136 opposite the swivel collar 138. In the illustrated embodiment of FIGS. 4A and 4B, the pinned connection is provided by a pair of legs 144 at the second end 142 of the pivot arm 136 that extend outward from the pivot arm 136 and a pin 147 positioned on the first end 145 of the door engagement arm 132. Thus, rotation of the door engagement arm 132 relative to the support plate 134 causes the pivot arm 136 to rotate about the support plate 134. This rotation of the pivot arm 136 in turn can cause a rod assembly (not shown in FIGS. 4A and 4B) attached to the swivel collar 138 to translate in first or second directions, depending on the direction of motion of the door engagement arm 132 (e.g., depending on whether the movement is driven by the opening or closing of a primary door).

As also noted above, in different embodiments, secondary interlock activators can be configured to be translated or rotated in order to move between disengaged and engaged positions and thereby to allow or not allow an associated secondary door to be opened. In the illustrated example, each of the secondary interlock activators 124, 128 is a sliding secondary interlock activator, whereas the secondary interlock activator 126 is a rotating secondary interlock activator. In the illustrated example, the secondary interlock activators 124, 128 are substantially identical, and thus the structures of only one will be discussed in detail herein. In other embodiments, however, sliding secondary interlock activators of different types can be used.

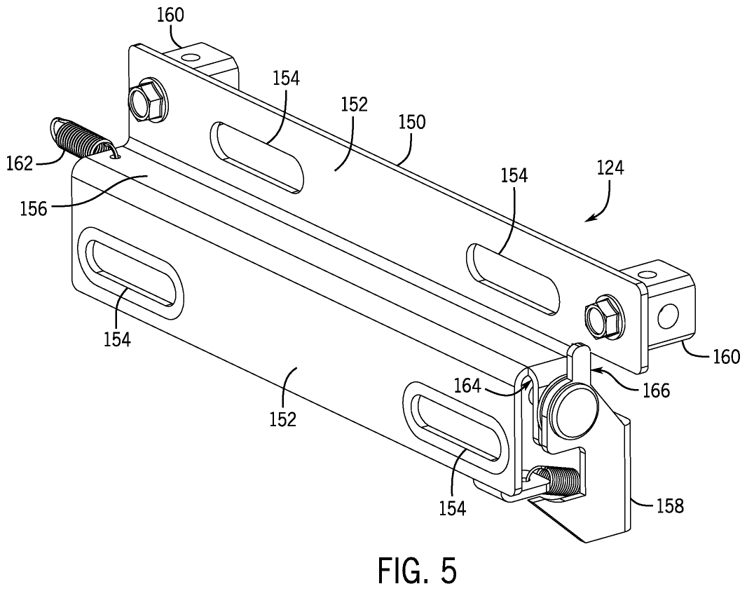

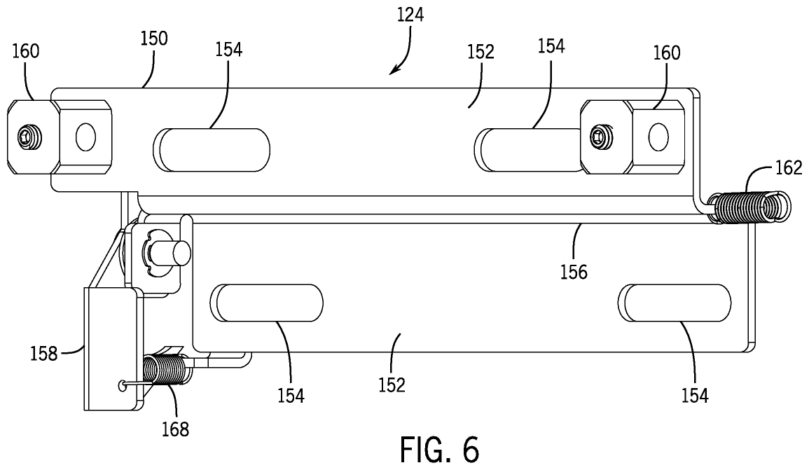

As shown in FIGS. 5 and 6 in particular, the secondary interlock activator 124 includes a slide body 150 that includes two slide plates 152 with slots 154, and a support flange 156 extending between the slide plates 152. As further discussed below, the slots 154 are configured to receive bushings of an enclosure, to allow the slide body 150 to be slidably secured to the enclosure above an associated secondary door for operation. In the illustrated example, the slots 154 are somewhat extruded on the lower slide plate 152, to provide for improved sliding performance, although other configurations are possible. Further, a biasing element 162 (e.g., a coil spring) may be provided to bias the secondary interlock activator 124 in a select (e.g., open or disengaged) direction.

This biased arrangement can be useful, including for other interlock activators, to streamline installation. For example, once a rod assembly has been secured to an interlock activator, a biasing element can cause the interlock activator to move to a default position without subsequent manual adjustment.

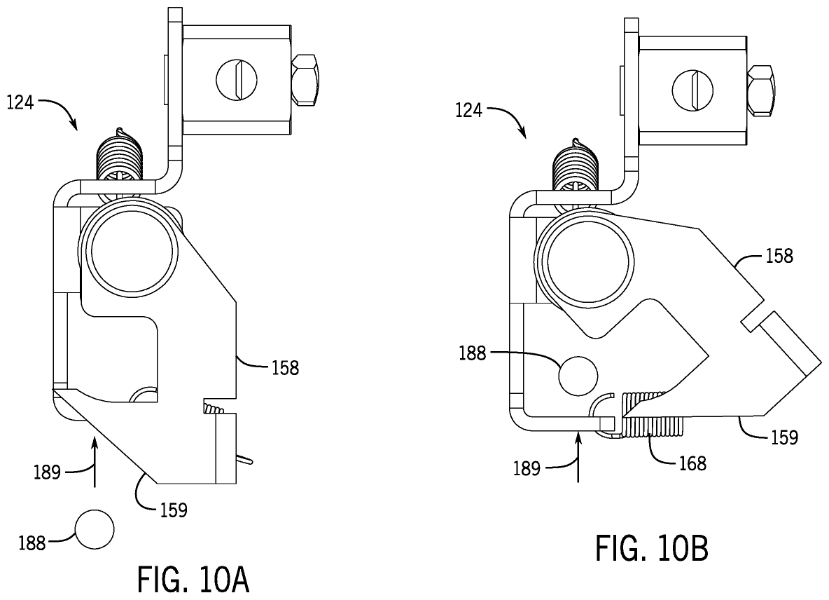

The secondary interlock activator 124 also includes a latch hook 158 that is pivotably secured to a tab 164 that depends from the support flange 156. Thus, the latch hook 158 can pivot between a closed position (as shown in FIG. 5 and FIG. 10A) and an open position (see, e.g., FIG. 10B). In the illustrated embodiment, the latch hook 158 is biased towards the closed position (e.g., using a biasing element 168, such as a coil spring, as shown in FIG. 6), and has an upwardly extending hard stop 166 to prevent over-rotation, although other configurations are possible.

The secondary interlock activator 124 also includes a set of swivel collars 160 that are rotatably supported on the upper slide plate 152. When secured to a rod assembly (e.g., rod assembly 130 shown in FIGS. 2 and 3), as also discussed below, the swivel collars 160 provide a pivotable connection between the rod assembly and the secondary interlock activator 124, so that translation of the rod assembly can cause the secondary interlock activator 124 to slide along an enclosure without the secondary interlock activator 124 being over-constrained.

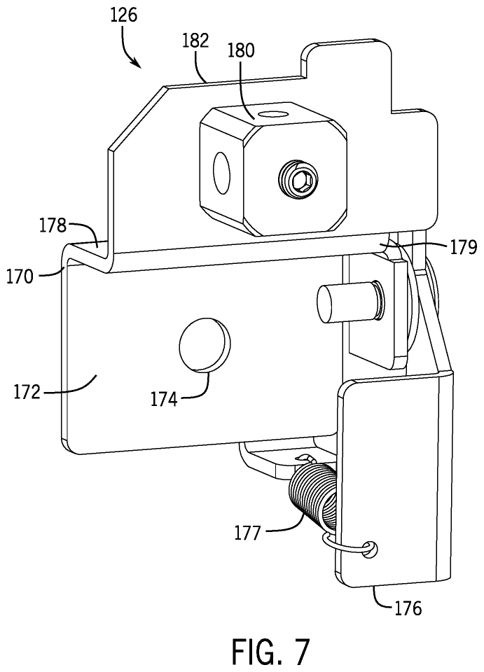

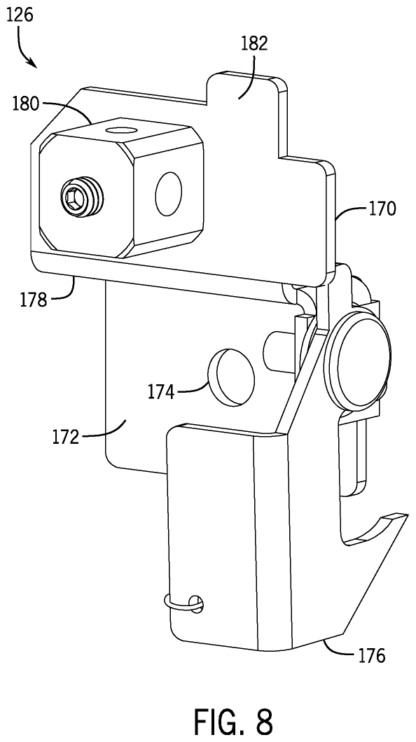

As shown in FIGS. 7 and 8 in particular, the secondary interlock activator 126 includes a pivot body 170 that includes a pivot plate 172 with an opening 174 therein. As further discussed below, the opening 174 is configured to receive a stud of an enclosure, to fix the pivot body 170 against translation and guide rotation of the pivot body 170 relative to the enclosure.

The secondary interlock activator 126 also includes a latch hook 176 that is pivotably secured to a tab 179 that depends from a support flange 178 of the secondary interlock activator 126. Thus, the latch hook 176 can pivot between a closed position (as shown in FIGS. 7 and 10A) and an open position (see, e.g., FIG. 10B). In the illustrated embodiment, the latch hook 176 is biased towards the closed position (e.g., using a biasing element 177, such as a coil spring, as shown in FIG. 7) and has an upwardly extending hard stop to prevent over-rotation, although other configurations are possible.

The secondary interlock activator 126 also includes a swivel collar 180 that is rotatably supported on an upper support plate 182. When secured to a rod assembly, as also discussed below, the swivel collar 180 can allow the translation of the rod assembly to cause the secondary interlock activator 126 to pivot relative to an enclosure.

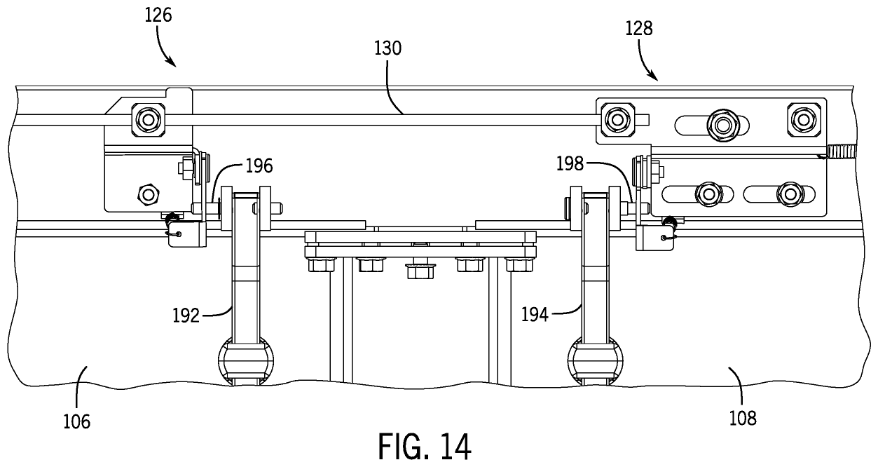

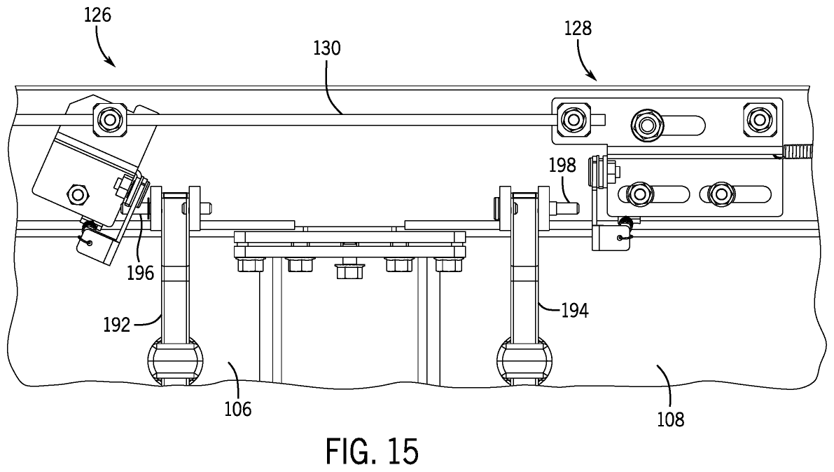

In the illustrated example, as also shown in FIGS. 14 and 15, offsets in the vertical and depth-wise (i.e., into the enclosure) directions are generally the same between the pivot plate 172 and, respectively, the swivel collar 180 and the latch hook 176, and between the slide plate 152 and, respectively, the swivel collars 160 and the latch hook 158 (see FIGS. 5 and 6). Thus, with the slide and pivot bodies 150, 170 supported at the same height above respective enclosure doors, the swivel collars 160, 180 can be aligned for connection via a common rod assembly and the latch hooks 158, 176 can be aligned at a common height to engage a respective latch rod. In other embodiments, however, other configurations are possible.

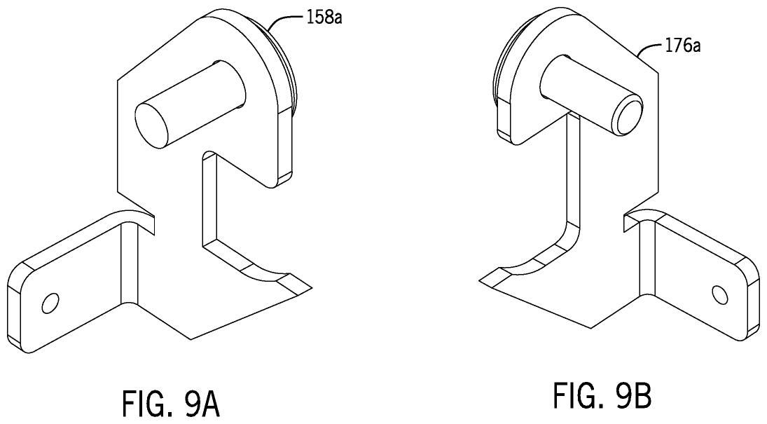

In some embodiments, reversed-geometry but otherwise similar latch hooks can be used to engage latches on opposing sides of a centerpost, or latches on other doors that otherwise open in opposite hinging directions. As shown in FIGS. 9A and 9B, for example, latch hooks 158a, 176a, can be formed with similar, but reversed geometries, for use, respectively, in slide bodies and pivot bodies similar to the slide and pivot bodies 150, 170. As also shown in FIGS. 10A and 10B in particular, it may be useful to provide latch hooks with angled geometries at surfaces (e.g., angled surface 159) that are to contact latch rods of associated secondary doors, in order to allow the latch rods to overcome any biasing force on the latch hooks as the latch rods are moved to engage the latch hooks (illustrated by the arrow 189). In FIGS. 10A and 10B, a latch rod is represented by circle 188. Thus, for example, latch rods can be readily moved into engagement with (i.e., moved to be locked into) the latch hooks even when the respective slide or pivot bodies are in the engaged positions and the latch hooks are closed. FIGS. 10A and 10B are side elevation views of operation of the secondary interlock activator of FIGS. 5 and 6 according to an embodiment. In FIG. 10A, the latch hook 158 of the secondary interlock activator 124 is shown in a closed position and in FIG. 10B, the latch hook 158 of the secondary interlock activator 124 is shown in an open position. As discussed above with respect to FIGS. 5 and 6, a biasing element 168 may be used to bias the latch hook 158 towards the closed position.

Use of modular, removable latch hooks can also be useful for other purposes. For example, to remove interlock control from a particular door, a user can simply remove the associated hook, rather than uninstall or otherwise substantially reconfigure other components of the interlock.

As generally discussed above, it may be possible for a rod assembly to extend across multiple enclosure bays in order to collectively move any number of slide or pivot bodies of an interlock as a primary door is opened or closed. In this regard, some rod assemblies can include couplers that secure multiple rods together, including into a generally linear multi-rod arrangement. A variety of coupler types can be used, including a tube coupler 184, as shown in FIG. 11A, or a slide coupler 186 with swivel collars, as shown in FIG. 11B. The slide coupler 186 may be used in isolation, or may be mounted to a bushing of an enclosure, for relatively constrained sliding movement.

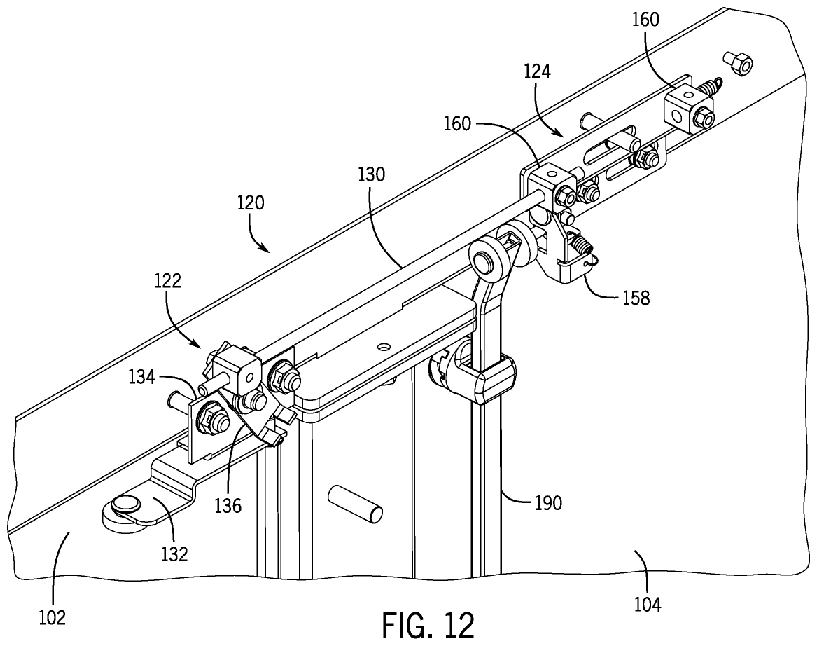

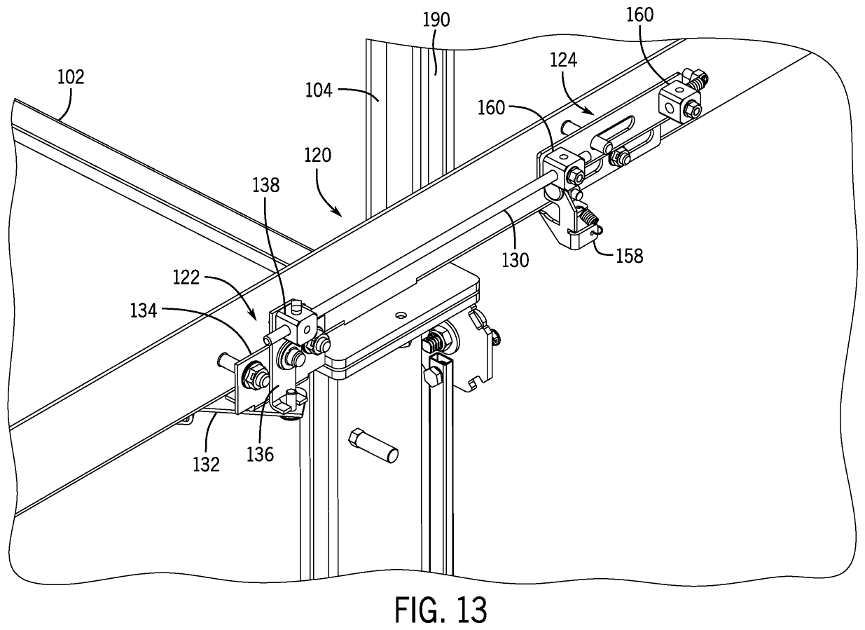

FIGS. 12 and 13 illustrate interoperation of the primary interlock activator 122 and the secondary interlock activator 124 of the interlock 120, with the secondary interlock activator 124 mounted above the secondary door 104 and the secondary door 104 configured to hinge open in the same direction as the primary door 102. As shown in FIG. 12 in particular, when the primary door 102 is closed, the door engagement arm 132 of the primary interlock activator 122 prevents the pivot arm 136 from pivoting about the support plate 134. Correspondingly, the rod assembly 130 is prevented from translating relative to the enclosure and the rod assembly 130, in turn, via one of the swivel collars 160, secures the secondary interlock activator 124 against translation away from the engaged position. Thus, an extension of a latch rod 190 for the secondary door 104 remains engaged with the latch hook 158 and the latch rod 190 cannot be moved to unlatch and open the secondary door 104.

In contrast, as shown in FIG. 13, when the primary door 102 is open, the door engagement arm 132 causes the pivot arm 136 to pivot about the support plate 134, which thereby, via the swivel collar 138, causes the rod assembly 130 to translate toward the secondary interlock activator 124. As a result, the secondary interlock activator 124 is also caused, via the rod assembly 130 and the relevant swivel collar 160, to translate. In particular, with sufficient movement of the primary door 104, the secondary interlock activator 124 can be moved from the engaged position shown in FIG. 12, in which the latch hook 158 secures the latch rod 190, to a disengaged position shown in FIG. 13, in which the latch hook 158 provides clearance for the latch rod 190 to be unlatched and the secondary door 104 to be opened.

In some embodiments, a biasing element (e.g., biasing element 162 shown in FIGS. 5 and 6) can be configured—as partly shown in FIGS. 12 and 13 for the secondary interlock activator 124—to bias an interlock activator towards a particular position. In other embodiments, however, no such bias may be provided.

Because each of the secondary interlock activators 124, 126, 128 of the interlock 120 are configured to be actuated by translation of the rod assembly 130, the same movement of the rod assembly 130 by the primary interlock activator 122, as discussed above, can also move the secondary interlock activators 126, 128 between engaged and disengaged positions. For example, when the primary door 102 is closed and the primary interlock activator 122 correspondingly maintains the rod assembly 130 in a fixed position, the secondary interlock activators 126, 128 are also held in respective engaged positions by the rod assembly 130. Thus, as shown in FIG. 14 in particular, the latch hooks of the secondary interlock activators 126, 128 remain engaged with extensions 196, 198 of respective latch rods 192, 194 and thereby prevent the latch rods 192, 194 from being unlatched and the secondary doors 106, 108 from being opened.

In contrast, as shown in FIG. 15, when the primary door 102 is opened (see FIG. 13) and the rod assembly 130 is correspondingly moved by the primary interlock activator 122, the rod assembly 130 causes the secondary interlock activator 128 to translate away from the latch rod 194 to the disengaged position and simultaneously causes the secondary interlock activator 126 to pivot the latch hook 176 away from the latch rod 192 to the disengaged position. Accordingly, once the primary door 102 is opened, the secondary doors 106, 108 can be opened as well.

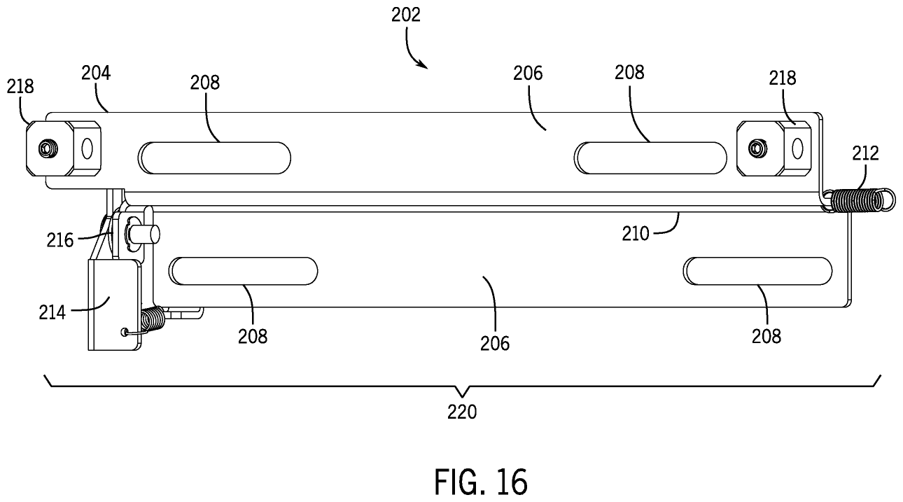

While the embodiment illustrated in FIGS. 14 and 15 shows a sliding secondary interlock activator 128 with three slots, sliding secondary interlock activators with four slots may be used, for example, the four slot sliding secondary interlock activator 124 shown in FIGS. 5 and 6. As mentioned above with respect to FIGS. 5 and 6, other configurations of the sliding secondary interlock activator may also be used. FIG. 16 is an isometric view of a secondary interlock activator for a secondary door of an enclosure according to an embodiment. Similar to the secondary interlock activator 124 shown in FIGS. 5 and 6, the secondary interlock activator 202 includes a slide body 204 that includes two slide plates 206 with slots 208, a support flange 210 extending between the slide plates 206, a basing element 212, a latch hook 214 that is pivotably secured to a tab 216 that depends from the support flange 210, and a set of swivel collars 218 that are rotatably supported on the upper slide plate 206. The elements of secondary interlock activator 202 operate in a similar manner as described above with respect to the secondary interlock activator 124 shown in FIGS. 5 and 6. However, the secondary interlock activator 202 has a longer length 220 than the length of the secondary interlock activator 124. In some embodiments, the secondary interlock activator 202 may be used in place of, for example, the secondary interlock activator 128 shown in FIGS. 14 and 15 or the secondary interlock activator 124 shown in FIGS. 12 and 13.

As illustrated in FIGS. 12-15 as well as in FIGS. 2 and 3, the interlock 120 can be secured to the enclosure 100 only on a frame upper portion thereof, above the openings for the various doors 102-110. In particular, in contrast to some conventional interlock arrangements, no part of the interlock 120 may need to be mounted to a centerpost of the enclosure 100. Further, because interlock force can be translated between the primary interlock activator 122 and the secondary interlock activators 124, 126, 128 by simple translation of the rod assembly 130, door control using the interlock 120 can be extended across multiple bays with relatively simple pass-throughs (see, e.g., FIG. 11A). Thus, the interlock 120 can be easily installed and maintained, and can remain in place during a variety of installation or maintenance operations for the enclosure 100 (e.g., as may require removal of a centerpost).

Generally, the particular configurations presented expressly above of primary interlock activators, secondary interlock activators, and associated enclosure doors should be considered as examples only. In other embodiments, other arrangements of primary interlock activators, secondary interlock activators, controlled doors, and other components are possible. For example, some configurations can include rod assemblies that extend from a primary interlock activator in an opposite direction than is shown in FIG. 12, with corresponding adjustments to secondary interlock activators, as needed, to ensure appropriate movement between engaged and disengaged positions. In some embodiments, rod assemblies may extend in two directions from a primary interlock activator. In some embodiments, primary or secondary doors can be configured to hinge open in different ways than is shown, again with corresponding adjustments to primary interlock activators and secondary interlock activators, as needed, to ensure appropriate operation (e.g., reversal of sliding or pivoting directions).

In some embodiments, different combinations of doors can be controlled by an interlock. For example, no door or a different combination of doors may be excluded from interlock control similarly to the secondary door 110 (see FIG. 1). Similarly, a different number or arrangements of secondary interlock activators than shown in the FIGs. can be used in various enclosures, as appropriate. Further, due to the relatively simple mechanical transmission of interlock forces (e.g., through extended rotatable rod arrangements), interlocks according to the present disclosure can be implemented in enclosures with a wide variety of internal configurations, including enclosures with barriers between enclosure bays, or with other structures through which mechanical motion can be transmitted (e.g., by physical passage of a translatable rod assembly).

The previous description of the disclosed embodiments is provided to enable any person skilled in the art to make or use the disclosed systems, apparatus and methods. Various modifications to these embodiments will be readily apparent to those skilled in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

1. An interlock for controlling doors on an enclosure, the enclosure including a primary door, a first secondary door and a second secondary door, the interface comprising:
a primary interlock activator positioned above the primary door and comprising a pivot arm having a first position and a second position, wherein the pivot arm is in the first position when the primary door is in a closed position and is in the second position when the primary door is in an open position;
a rod assembly coupled to the primary interlock activator;
a first secondary interlock activator positioned above the first secondary door and coupled to the rod assembly, the first secondary interlock activator comprising:
a slide body that is slidably secured to the enclosure;
a latch hook that is rotatably supported on the slide body; and
a swivel collar that is rotatably supported on the slide body;
wherein the first secondary interlock activator has an engaged position and a disengaged position;
wherein first secondary interlock activator is in the engaged position when the primary door is in the closed position and is in the disengaged position when the primary door is in the open position; and
a second secondary interlock activator positioned above the second secondary door and coupled to the rod assembly, the second secondary interlock activator comprising:
a pivot body that is rotatably secured to the enclosure;
a latch hook that is rotatably supported on the pivot body; and
a swivel collar that is rotatably supported on the pivot body;
wherein the second secondary interlock activator has an engaged position and a disengaged position;
wherein second secondary interlock activator is in the engaged position when the primary door is in the closed position and is in the disengaged position when the primary door is in the open position.

2. The interlock according to claim 1, wherein the slide body of the first secondary interlock activator incudes a slide plate with slots configured to receive a busing of the enclosure to guide slidable movement of the slide body relative to the enclosure.

3. The interlock according to claim 1, wherein the latch hook of the first secondary interlock activator has an open configuration and a closed configuration and includes a biasing element to bias the latch hook towards the closed configuration.

4. The interlock according to claim 1, wherein the swivel collar of the first secondary interlock activator is configured to secure the slide body against translation relative to the rod assembly.

5. The interlock according to claim 1, wherein the pivot body of the second secondary interlock activator includes a picot plate configured to receive a stud of the enclosure to guide rotation of the pivot body relative to the enclosure.

6. The interlock according to claim 1, wherein the latch hook of the second secondary interlock activator has an open configuration and a closed configuration and includes a biasing element to bias the latch hook towards the closed configuration.

7. The interlock according to claim 1, wherein the swivel collar of the second secondary interlock activator is configured to secure the pivot body against translation relative to the rod assembly.

8. The interlock assembly according to claim 1, wherein in the first secondary interlock activator further comprises:
a support plate coupled to the enclosure, wherein the pivot arm is pivotably secured to the support plate;
a swivel collar coupled to a first end of the pivot arm and coupled to the rod assembly; and
a door engagement arm rotatably coupled to the support plate at a first end of the door engagement arm.

9. The interlock according to claim 8, wherein the pivot arm includes a pair of legs on a second end of the pivot arm, the pair of legs extending outward from the second end of the pivot arm, and wherein the door engagement arm includes a pin on the first end of the door engagement arm, wherein the pin is positioned between the pair of legs of the pivot arm.

10. The interlock according to claim 8, wherein the door engagement arm includes a roller element rotatably secured to a second end of the door engagement arm.

11. The interlock according to claim 8, wherein the support plate of the primary interlock activator is coupled to a top frame of the enclosure above the primary door.

12. The interlock according to claim 1, wherein the first secondary interlock activator includes a biasing element and the second secondary interlock activator includes a biasing element.

13. The interlock according to claim 1, wherein the slide body of the first secondary interlock activator is slidably secured to a top frame of the enclosure above the first secondary door and the pivot body of the second secondary interlock activator is rotatably secured to a top frame of the enclosure above the second secondary door.

14. An interlock for controlling doors on an enclosure, the enclosure including a primary door, a first secondary door and a second secondary door, the interlock comprising:
a primary interlock activator positioned above the primary door and coupled to a rod assembly, the primary interlock activator configured to translate the rod assembly relative to the enclosure upon movement of the primary door;
a first secondary interlock activator positioned above the first secondary door and coupled to the rod assembly, the first secondary interlock activator including a latch hook and configured to slide along an interior of the enclosure upon translation of the rod assembly and move the latch hook between an engaged position and a disengaged position relative to a latch of the first secondary door; and
a second secondary interlock activator positioned above the second secondary door and coupled to the rod assembly, the second secondary interlock activator including a latch hook and configured to rotate relative to the interior of the enclosure upon translation of the rod assembly and move the latch hook between an engaged position and a disengaged position relative to a latch of the second secondary door.

15. The interlock according to claim 14, wherein the first secondary door and the second secondary door are disposed on opposite sides of a common centerpost and wherein the first secondary interlock activator is configured to be slid away from the centerpost by a first translation of the rod assembly to move the latch hook of the first secondary interlock activator to the disengaged position and wherein the second secondary interlock activator is configured to be pivoted by the first translation of the rod assembly to move the latch hook of the second secondary interlock activator away from the centerpost to the disengaged position.

16. The interlock according to claim 14, wherein the first secondary interlock activator and latch hook are configured to be placed in the engaged position by the translation of the rod assembly when the primary door is in a closed position, to prevent the first secondary door from being opened,

17. The interlock according to claim 16, wherein the first secondary interlock activator and latch hook are configured to be placed in the disengaged position by the translation of the rod assembly when the primary door is in an open position, to allow the first secondary door to be opened.

18. The interlock according to claim 14, wherein the second secondary interlock activator and latch hook are configured to be placed in the engaged position by the translation of the rod assembly when the primary door is in a closed position to prevent the second secondary door from being opened, and wherein the second secondary interlock activator and latch hook are configured to be placed in the disengaged position by the translation of the rod assembly when the primary door is in an open position, to allow the second secondary door to be opened.

19. The interlock according to claim 14, wherein the first secondary interlock activator further includes a slide body slidably secured to the enclosure and a swivel collar rotatably supported on the slide body, wherein the latch hook of the first secondary interlock activator is rotatably supported on the slide body, and wherein the second secondary interlock activator further includes a pivot body rotatably secured to the enclosure and a swivel collar rotatably supported on the pivot body, wherein the latch hook of the second secondary interlock activator is rotatably supported on the slide body.

20. An interlock for controlling doors on an enclosure, the enclosure including a primary door, a first secondary door and a second secondary door, the interlock comprising:
a primary interlock activator positioned above the primary door and coupled to a rod assembly, the primary interlock activator configured to translate the rod assembly relative to the enclosure upon movement of the primary door;
a first secondary interlock activator positioned above the first secondary door and coupled to the rod assembly, the first secondary interlock activator configured to slide along an interior of the enclosure between an engaged position and a disengaged position in response to the translation of the rod assembly; and
a second secondary interlock activator positioned above the second secondary door and coupled to the rod assembly, the second secondary interlock activator configured to rotate relative to the interior of the enclosure between an engaged position and a disengaged position in response to the translation of the rod assembly and move.
